(19) United States
(12) Patent Application Publication
(10) Pub. No.: US 2005/0013345 A1
(43) Pub. Date: Jan. 20, 2005

(54) Method for ultra wideband communication using frequency band modulation, and system for the same

(75) Inventor: Yun-hwa Choi, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/892,448

(22) Filed: Jul. 16, 2004

Related U.S. Application Data
(60) Provisional application No. 60/488,395, filed on Jul. 21, 2003.

(30) Foreign Application Priority Data
Jul. 18, 2003 (KR) 10-2003-0049160

(51) Int. Cl. H04B 1/69

(52) U.S. Cl. 375/130

(57) ABSTRACT

Provided are a method and system for ultra wideband (UWB) wireless communication using frequency band modulation (FBM). The method includes grouping digital data in unit of a predetermined number n of bits to produce bit groups and modulating the bit groups to generate UWB signals of m subbands having different center frequencies mapped according to the type of each bit group, transmitting the generated UWB signals over at least one wireless channel, and receiving the UWB signals transmitted over the wireless channel(s) and demodulating the received USB signals into digital data using a predetermined demodulation method. The system includes a transmitter and a receiver that together carry out the method. The method and system for UWB communication using multiple bands enable high rate data transmission.

### BACKGROUND OF THE INVENTION

This application claims the priorities of Korean Patent Application No. 2003-0049160 filed on Jul. 18, 2003, with the Korean Intellectual Property Office, and U.S. Provisional Application No. 60/488,395 filed on Jul. 21, 2003, with the United States Trademark and Patent Office, the disclosures of which are incorporated herein in its entirety by reference.

1. Field of the Invention

The present invention relates to a method and system for ultra wideband wireless communication, and more particularly, to a method and system for ultra wideband wireless communication using frequency band modulation (FBM).

2. Description of the Related Art

Recently, rapid advances in wireless communication technology and proliferation of wireless devices have led to a tremendous change in the way people live. In particular, ultra wideband (to be abbreviated as “UWB”) communication, which enables high-speed wideband wireless communication while coexisting with conventional wireless communication service without acquisition of additional frequency resources, has been recently researched.

A UWB communication system utilizes short pulses (wavelets) having a bandwidth of several GHz. In the UWB communication system, data is communicated without using a carrier, thus consuming less power than in the conventional communication. Also, since a UWB signal used in the UWB communication is detected at less than a noise level in a frequency domain, it can be advantageously used without interference between other devices. Meanwhile, since the UWB has a pulse of a very small duty cycle, it offers various advantages including a high transfer rate, multiple access implementation, and low multipath interference.

Although the UWB communication can be applied for various uses, present studies tend to focus on high-rate, short-range, i.e., in a range of several to several tens of meters, communication methods. Since a UWB communication method enables high-speed data transmission, ultra high quality images based on digital high-definition television broadcasting or digital versatile disk (DVD) can be transmitted in the form of streaming data using UWB communication methods.

Currently proposed available signal modulation techniques for UWB communication include pulse position modulation (PPM) using positional change on time slots of a UWB pulse (UWB wavelet), pulse amplitude modulation (PAM) using the amplitude of a pulse, phase shift keying (PSK) such as binary phase shift keying (BPSK) or quadrature phase shift keying (QPSK), orthogonal frequency division modulation (OFDM), and a combination of these techniques, e.g., a combination of BPSK and PPM.

These techniques have been proposed in attempts to minimize a noise level while maximizing the quantity of information to be transmitted (received). However, increasing the quantity of information to be actually transmitted using the techniques may degrade the accuracy of the signal level. In addition, existing techniques do not provide a sufficiently satisfactory solution to allow detection of extremely short pulses and acquisition of phase information and synchronization at a receiver end, which are required to carry out data communication based on a phase difference of pulses.

### SUMMARY OF THE INVENTION

To solve the above-described problems, it is an object of the present invention to provide a method and system for UWB communication which allows for a high data transfer rate with a reduced number of UWB pulses and a system using the same.

In an aspect of the present invention, there is provided a method for ultra wideband (UWB) communication using frequency band modulation comprising grouping digital data in units of a predetermined number n of bits to produce bit groups and modulating the bit groups to generate first UWB signals of m subbands having different center frequencies mapped according to the type of each bit group, transmitting the generated first UWB signals over at least one wireless channel, and receiving second UWB signals transmitted over the wireless channel(s) and demodulating the received second USB signals into digital data using a predetermined demodulation method.

The modulating of the grouped digital data may comprise generating the UWB signals of m subbands mapping to the bit groups in the order of the bit groups.

The demodulating of the second USB signals may comprise generating bit groups mapping to the respective subbands after detecting the received UWB signals for the corresponding subbands, and generating digital data using the generated bit groups. Also, the generating of the bit groups may comprise integrating energy levels of the second UWB signals each having passed through a bandpass filter for each subband by the length of each second UWB signal, and generating the bit groups mapping to the subbands whose integrated values are greater than a predetermined magnitude.

The predetermined number n of bits forming the bit groups is preferably defined by Equation below:

n=[log₂ m]

where m denotes the number of available subbands and the value of log₂m is a natural number.

In accordance with another aspect of the present invention, there is provided a system for ultra wideband (UWB) communication using frequency band modulation comprising a transmitter that groups digital data in units of a predetermined number n of bits to produce bit groups, modulates the bit groups into first UWB signals of m subbands having different center frequencies mapped according to the type of each bit group, and transmits the generated first UWB signals over wireless channels, and a receiver that receives second UWB signals transmitted over the wireless channels and demodulates the received second USB signals into digital data using a predetermined demodulation method.

The transmitter may comprise an input unit that receives digital data, m UWB signal generators that generate UWB signals of m subbands having different center frequencies, a bit group mapping unit that groups the digital data in units of the predetermined number of bits to produce bit groups and activates the UWB signal generators each generating the UWB signals of m subbands mapped to the respective bit groups, and a radio frequency (RF) transmitting unit of the mapped subbands over wireless channels.

The receiver may comprise signal detectors for m subbands having different center frequencies, and a bit group mapping unit that generates bit groups mapped to signals input to the signal detectors and generates digital data using the generated bit groups. Each of the signal detectors may comprise a bandpass filter for filtering the frequency of each subband, and an energy detector.

Here, the predetermined number n of bits forming each bit group is preferably defined by Equation below:
n=[log₂ m]
where m denotes the number of available subbands and the value of log₂m is a natural number.

### BRIEF DESCRIPTION OF THE DRAWINGS

The above aspects and advantages of the present invention will become more apparent by describing in detail illustrative, non-limiting embodiments thereof with reference to the attached drawings in which:

FIG. 1 shows power levels of a UWB signal having four subbands in a frequency domain;

FIGS. 2A and 2B are exemplary mapping tables for the respective subbands of the UWB signal mapped to bit groups according to an embodiment of the present invention;

FIG. 3 is a block diagram showing a transmitter and a receiver for UWB communication according an embodiment of the present invention;

FIG. 4 is a block diagram of a UWB signal generator shown in FIG. 3;

FIG. 5 is a function block diagram of a signal detector shown in FIG. 3;

FIG. 6 is a flow diagram showing a transmission/reception process of a UWB signal according to the present invention; and

FIG. 7 shows an actual data transmission process using a UWB signal having four subbands.

### DETAILED DESCRIPTION OF THE INVENTION

Advantages and features of the present invention and methods for accomplishing the same will now be described more fully with reference to the accompanying drawings, in which illustrative, non-limiting embodiments of the invention are shown.

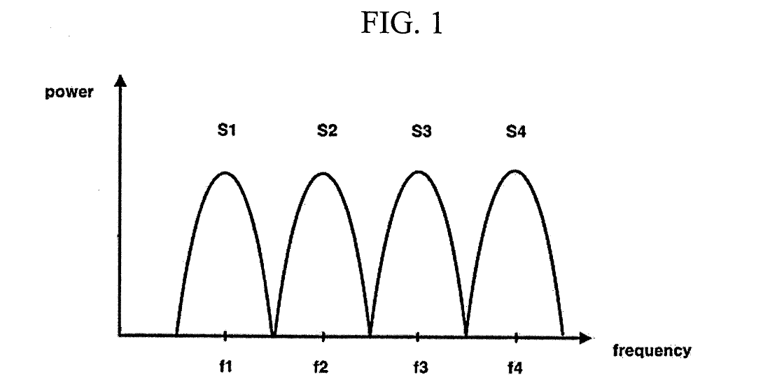

FIG. 1 shows power levels of UWB signals having four subbands having center frequencies f1, f2, f3, and f4, respectively, in a frequency domain. In the present embodiment, the UWB signal having a center frequency f1 has a symbol S1. Likewise, the UWB signals having center frequencies f2, f3, and f4 have symbols S2, S3, and S4, respectively. It can be generalized that subbands having m center frequencies produce m symbols S1 through Sm. The respective symbols can be mapped to different bit groups consisting of one or more bits. As described above, a modulation technique in which data transmission is carried out independently over each subband, is called frequency band modulation (FBM).

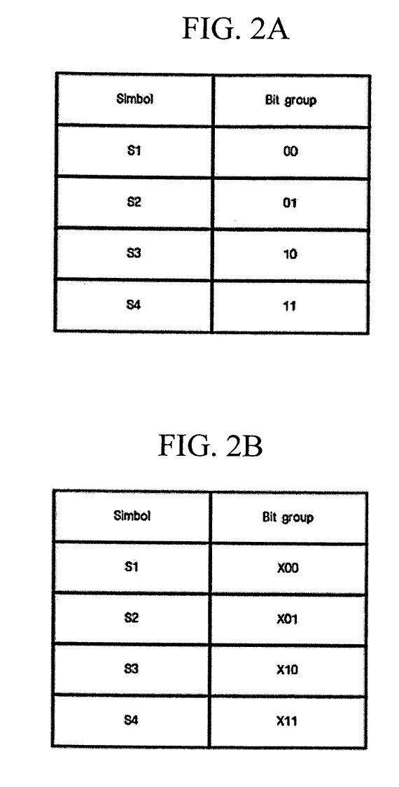

FIGS. 2A and 2B are exemplary mapping tables for the respective subbands of the UWB signals mapped to bit groups according to an embodiment of the present invention.

Referring to FIG. 2A, the symbol S1 is mapped to a bit group consisting of 2 bits “00” and the symbols S2, S3, and S4 are mapped to bit groups “01”, “10”, and “11”, respectively. FIG. 2B shows the symbols S1 through S4 mapped to bit groups each consisting of 3 or more bits, respectively. The respective bit groups are distinguished from one another by two last bits among bits forming each bit group. Thus, when the two last bits of a bit group are “00”, S1 is mapped to the bit group. When the two last bits are “01”, S2 is mapped to the bit group. When the two last bits are “10”, S3 is mapped to the bit group. When the two last bits are “11”, S4 is mapped to the bit group. For example, since a bit group consisting of four bits “1111” is represented as “X11”, S4 is mapped thereto. Likewise, since a bit group consisting of three bits “001” is represented as “X01”, S2 is mapped thereto. Meanwhile, when the respective symbols are to be mapped to bit groups each consisting of one single bit, the symbols S1 and S2 may be mapped to bit groups each consisting of one bit “0”, and the symbols S3 and S4 may be mapped to bit groups each consisting of one bit “1”. Of course, the symbols S1, S2, and S3 may be mapped to bit groups each consisting of one bit “0”, while the symbol S4 maps to a bit group consisting of one bit “1”.

A technical feature of the present invention is to represent UWB signals having different center frequencies using symbols, which are then mapped to bit groups consisting of one or more bits, for data transmission. In an exemplary embodiment, a bit group consisting of n bits is mapped to a UWB signal having m different center frequencies, which is defined in Equation 1 below:
n=log₂ m [Equation 1]
where m and n are each independently a natural number.

When the value of log₂m is greater than n, the bit group is preferably constructed to satisfy n=[log₂m], where two or more symbols are mapped to a bit group to have redundancy of data bits.

As shown in FIG. 2B, when the value of log₂m is smaller than n, all bits forming a bit group cannot be accurately represented just by using FBM, and a combination of different modulation techniques must be employed. UWB communication using a combination of BPSK and FBM techniques, for example, enables approximately two times more bit groups than subbands to be distinguished from one another. In other words, when a UWB signal having 8 subbands employs the FBM method, 3-bit data can be transmitted using one UWB pulse. When the UWB employs a combination of FBM and BPSK techniques, 4-bit data can be transmitted.

Thus, the UWB communication using FBM according to the present invention can be combined with any modulation technique applicable to multiband UWB communication methods. In this case, the information corresponding to the sum of the number of bits transmitted by the modulation technique and the number of bits transmitted by the FBM technique can be transmitted by a single UWB pulse.

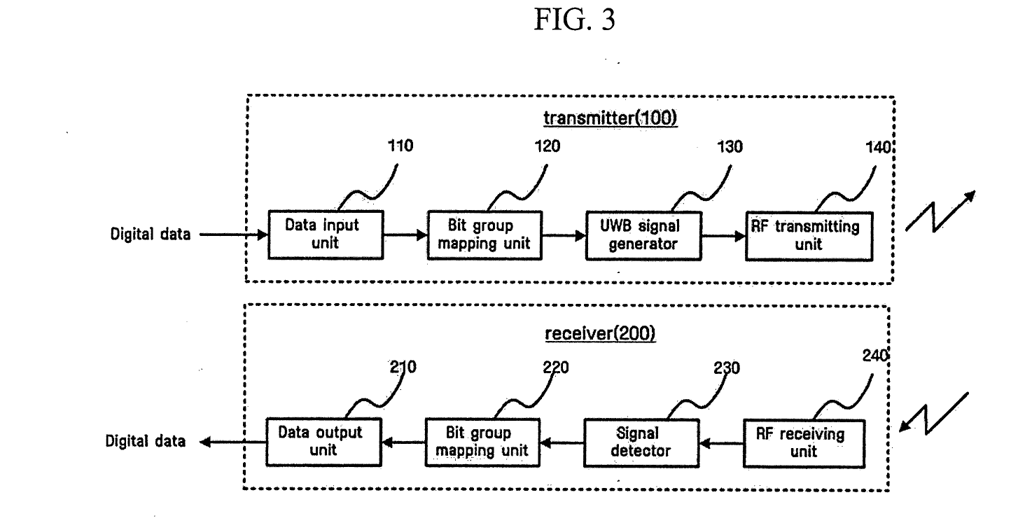

FIG. 3 is a block diagram showing a transmitter 100 and a receiver 200 for UWB communication according an embodiment of the present invention.

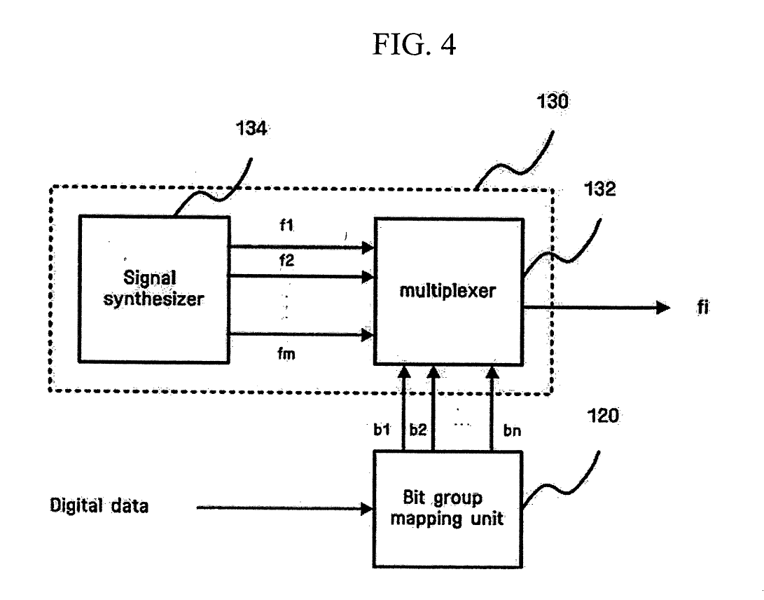

The transmitter 100 includes a data input unit 110 that serves as an interface for inputting external digital data, a bit group mapping unit 120 for grouping and mapping the digital data input through the data input unit 110 to produce bit groups, a UWB signal generator 130 for generating UWB signals having symbols mapped to the bit groups output from the bit group mapping unit 120, and a radio frequency (RF) transmitting unit 140 for transmitting the generated UWB signals over wireless channels. An exemplary illustration of the UWB signal generator 130 will later be described with reference to FIG. 4.

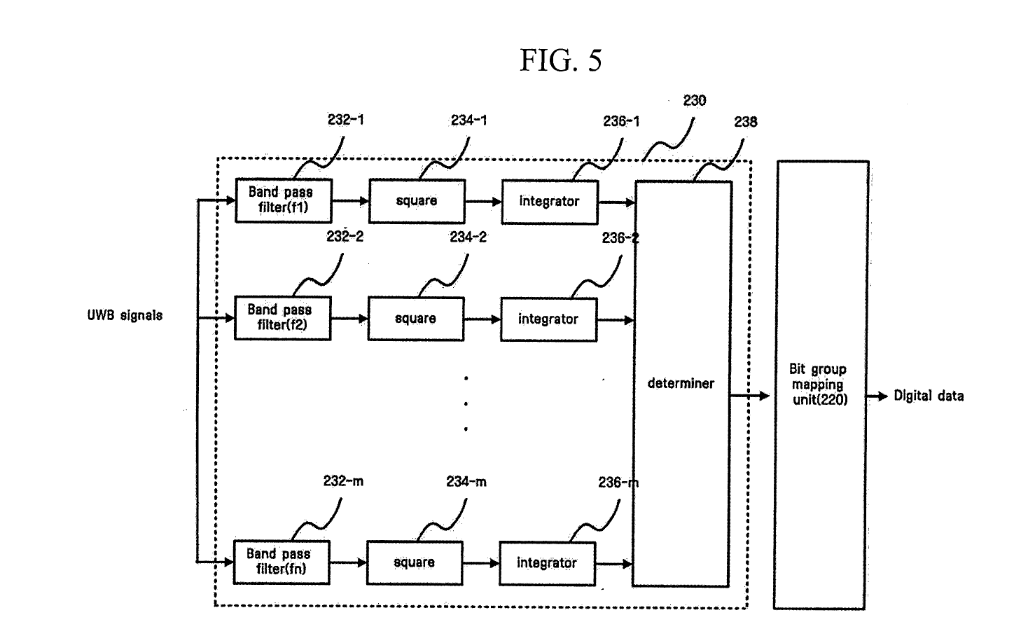

The receiver 200 includes an RF receiving unit 240 for receiving the UWB signals transmitted over the wireless channels, a signal detector 230 for detecting which subbands the UWB signals received by the RF receiving unit 240 are derived from, a bit group mapping unit 220 that produces bit groups, maps the bit groups to the subbands of the UWB signals detected from the signal detector 230 and generates digital data, and a data output unit 210 that serves as an interface for outputting the digital data input from the bit group mapping unit 220 to the outside. An exemplary illustration of the signal detector 230 will later be described with reference to FIG. 5.

FIG. 4 is a block diagram of the UWB signal generator 130 shown in FIG. 3.

The signal generator 130 includes a signal synthesizer 134 that generates m UWB signals having different center frequencies, and a multiplexer 132 that selectively outputs one of the m UWB signals generated from the signal synthesizer 134.

The UWB signal detector 130 operates as follows. When the digital data is input to the bit group mapping unit 120, the bit group mapping unit 120 groups and maps the digital data into groups in units of n bits. When n bits of digital data are input, the bit group mapping unit 120 groups the input bits and transmits control signals having n bits, that is, b1 through bn, to the multiplexer 132. The multiplexer 132 outputs a UWB signal having the corresponding center frequency (=fi) in response to the control signal. FIG. 4 illustrates a UWB communication method using only FBM, in which when the FBM technique is combined with BPSK, the bit group mapping unit 120 transmits a control signal, e.g., bn, to the signal synthesizer 134 so that the phase of the UWB signal generated at the signal synthesizer 134 becomes 0 or 180 degrees according to the type of the bit sequence of the control signal, for example, bn. Likewise, when the FBM technique is combined with other UWB modulation technique, some bits are used for the corresponding UWB modulation technique combined with the FBM technique and the other bits are used for the FBM technique.

FIG. 5 is a function block diagram of the signal detector shown in FIG. 3.

The signal detector 230 is preferably, but not necessarily, an energy detector for converting an electromagnetic wave in a particular band into heat energy. In an exemplary embodiment of the present invention, in order to detect USB signals having m subbands having different center frequencies, m energy detectors are employed. The signal detector 230 includes m bandpass filters 232-1 through 232-m for the respective subbands, m squaring means 234-1 through 234-m for squaring input signals, m integrators 236-1 through 236-m for integrating the squared signals in given period units, and a determiner 238 for determining the value of which integrator among the integrators 236-1 through 236-m is largest in given period units. For example, assuming that a UWB signal having a symbol S2 is input to the signal detector 230, a UWB signal having a center frequency f2 passes through the bandpass filter 232-2 while only noise passes through the other bandpass filters. The USB signal having passed through the bandpass filter 232-2 is squared to then be applied to the corresponding integrator. Among the integrators 236-1 through 236-m, the integrator 236-2 to which the UWB signal, rather than noise, is applied will have the largest value. Thus, the determiner 238 determines that the UWB signal having the center frequency f2 is input to the bit group mapping unit 220. Then, the determiner 238 notifies the bit group mapping unit 220 of the fact that the UWB signal having a symbol S2 is input thereto. The bit group mapping unit 220 outputs digital data corresponding to the symbol S2.

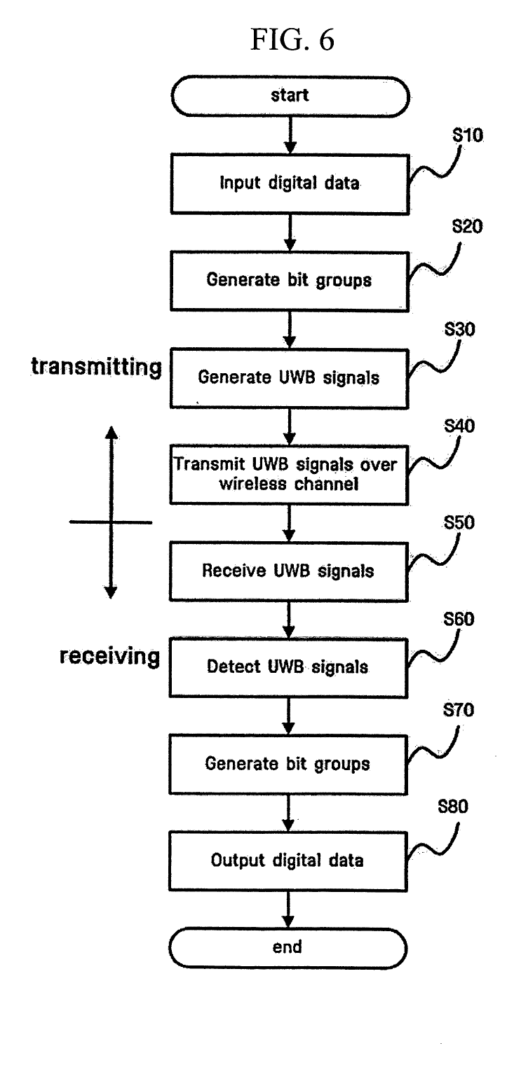

FIG. 6 is a flow diagram showing a transmission/reception process of UWB signals according to an aspect of the present invention.

First, digital data in the form of bitstreams is input in step S10. The input digital data is grouped in units of n bits to generate bit groups in step S20. In step S30, UWB signals mapped according to types of input bit groups, that is, symbols, which are determined by bits forming the bit group, are generated. The generated UWB signals are transmitted over wireless channels in step S40. In such a manner, the USB signals are transmitted using FBM in steps S10 through S40.

At a receiver end, the UWB signals transmitted over the wireless channels are received through antennas in step S50. It is determined from which subbands the received UWB signals are derived in step S60. Bit groups are generated according to the determination result in step S70. The bit groups are converted into digital data to then be output in step S80.

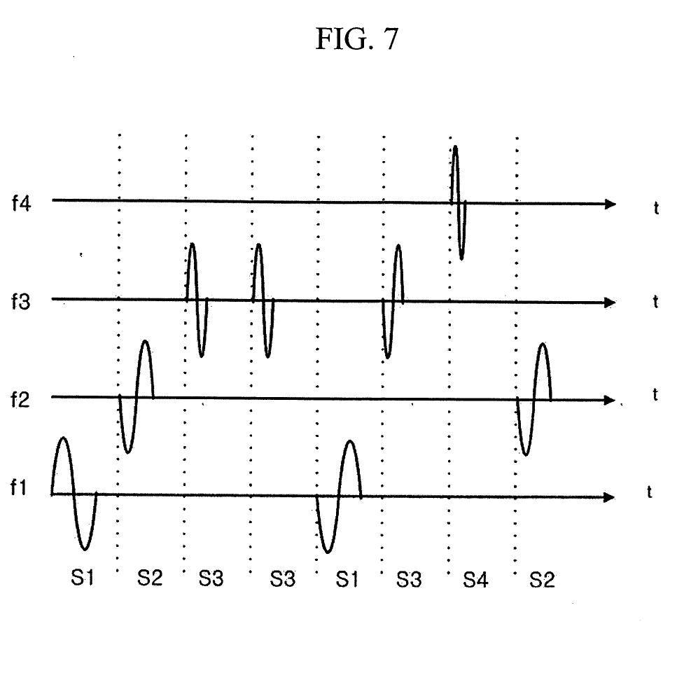

FIG. 7 shows an actual data transmission process using UWB signals having four subbands, in which the USB signals having respective center frequencies f1 through f4 have symbols S1 through S4. The symbols of the UWB signals are transmitted in the order S1, S2, S3, S3, S1, S3, S4 and S2. In the case where the symbols are mapped to the bit groups as shown in FIG. 2A, the bit groups transmitted by the UWB signals shown in FIG. 7 are “00”, “01”, “10”, “10”, “00”, “10”, “11”, “01”. Thus, the transmitted digital data streams are patterned as “00011010000101101 ”.

It will be understood that the FBM method shown in FIG. 7 for transmitting and receiving symbols can be combined with another modulation technique, such as BPSK, as described above, so that each symbol may contain more bits than when using the FBM method alone.

It will be understood by those skilled in the art that the foregoing and other changes in form and details may be made therein without departing from the spirit and scope of the invention which should be limited only by the scope of the appended claims. For example, while the illustrative preferred embodiment has shown that the signal detector was implemented by an energy detector, it can be implemented by a mixer, synchronizing means and an integrator like in the conventional technology.

Thus, preferred embodiments of the invention disclosed above are used in a generic and descriptive sense only and not for purposes of limitation. The described embodiments are to be considered in all respects only as illustrative and not restrictive and the scope of the invention is, therefore, indicated by the appended claims rather than the foregoing description. All changes which come within the meaning and range of equivalency of the claims are to be embraced within their scope.

As described above, the multiband UWB communication method according to the present invention can achieve a high data transfer rate in proportion to the number of bands.

1. A method for ultra wideband (UWB) communication using frequency band modulation comprising:
grouping digital data in units of a predetermined number n of bits to produce first bit groups and modulating the first bit groups to generate first UWB signals of m subbands having different center frequencies mapped according to the bits of each of the first bit groups;
transmitting the generated first UWB signals over at least one wireless channel; and
receiving second UWB signals and demodulating the received second UWB signals into digital data using a predetermined demodulation method.

2. The method of claim 1, wherein the modulating the first bit groups comprises generating the first UWB signals of m subbands mapping to the first bit groups in the order of the first bit groups.

3. The method of claim 1, wherein the demodulating the received second UWB signals comprises generating second bit groups mapping to the respective subbands after detecting the received second UWB signals for the corresponding subbands, and generating digital data using the generated second bit groups.

4. The method of claim 3, wherein the generating the second bit groups comprises integrating energy levels of the second UWB signals each having passed through a bandpass filter for each subband by the length of each second UWB signal, and generating the second bit groups mapping to the subbands whose integrated values are greater than a predetermined magnitude.

5. The method of claim 1, wherein the predetermined number n of bits forming the first bit groups is defined by Equation below:
n=[log₂ m]
where m denotes the number of available subbands.

6. The method of claim 5, wherein the value of log₂m is a natural number.

7. A system for ultra wideband (UWB) communication using frequency band modulation comprising:
a transmitter that groups digital data in units of a predetermined number n of bits to produce first bit groups, modulates the first bit groups into first UWB signals of m subbands having different center frequencies mapped according to the bits of each of the first bit groups, and transmits the generated first UWB signals over at least one wireless channel; and
a receiver that receives second UWB signals and demodulates the received second USB signals into digital data using a predetermined demodulation method.

8. The system of claim 7, wherein the transmitter comprises:
an input unit that receives digital data;
m UWB signal generators that generate first UWB signals of m subbands having different center frequencies;
a bit group mapping unit that groups the digital data in units of the predetermined number of bits to produce the first bit groups and activates the UWB signal generators each generating the first UWB signals of m subbands mapped to the respective first bit groups; and
a radio frequency (RF) transmitting unit that transmits the mapped subbands over the at least one wireless channel.

9. The system of claim 7, wherein the receiver comprises:
signal detectors for m subbands having different center frequencies; and
a bit group mapping unit that generates second bit groups mapped to signals input to the signal detectors and generates digital data using the generated second bit groups.

10. The system of claim 9, wherein each of the signal detectors comprises a bandpass filter for filtering the frequency of each subband, and an energy detector.

11. The system of claim 7, wherein the predetermined number n of bits forming each bit group is defined by Equation below:
n=[log₂ m]
where m denotes the number of available subbands.

12. The system of claim 11, wherein the value of log₂m is a natural number.
